(19) United States
(12) Patent Application Publication
(10) Pub. No.: US 2022/0097936 A1
(43) Pub. Date: Mar. 31, 2022

(54) BIODEGRADABLE FOOD ARTICLES AND METHODS OF PRODUCING SAME

(71) Applicant: AECOPAQ INC., JOLIETTE (CA)

(72) Inventors: Michel AUFOUJAL, Montréal (CA); James GABAY, Dollard-des-Ormeaux (CA)

(73) Assignee: AECOPAQ INC., JOLIETTE, QC (CA)

(21) Appl. No.: 17/600,066

(22) PCT Filed: Mar. 26, 2020
(86) PCT No.: PCT/CA2020/050396

§ 371 Date: Sep. 29, 2021

Related U.S. Application Data
(60) Provisional application No. 62/826,151, filed on Mar. 29, 2019.

(51) Int. Cl. B65D 65/46; B27N 5/00; B65D 1/36; B27N 1/00; B27N 3/04

(52) U.S. Cl. CPC B65D 65/466; B27N 5/00; B27N 3/04; B27N 1/006; B65D 1/36

(57) ABSTRACT

There is provided herein a method for producing biodegradable food articles. The method comprises providing raw fibers; reducing the size of the raw fibers; mixing the fibers with a liquid to obtain a slurry; mixing at least one additive to the slurry, and thermoforming the slurry to obtain the biodegradable food article. Also provided herein are biodegradable food articles and in particular biodegradable food trays produced according to the method disclosed herein.

### CROSS-REFERENCE TO RELATED APPLICATIONS

The present disclosure claims priority to U.S. application No. 62/826,151 filed on Mar. 29, 2019. This application is hereby incorporated by reference in its entirety.

### FIELD

The present disclosure relates to biodegradable food articles and more particularly to biodegradable food articles comprising natural fibers as well as methods of producing such articles.

### BACKGROUND

The environmental situation is a concern everywhere in the world. Tons of non-biodegradable products are poured in the environment every single day contributing to greenhouse gas emissions.

In addition to valorization of residual fibers, fiber-containing packaging fit in the category of eco-friendly, biodegradable, recyclable and compostable packaging, reduces plastic wastes and the associated impact to the environment. Thus fiber-containing packaging material can be offered as an alternative to polluting oil-based Styrofoam packaging.

Nowadays, there is increasing public and governmental concern regarding plastic waste. In 2010, 275 million metric tons (MT) of plastic waste were generated in 192 coastal countries with 4.8 to 12.7 million MT of waste entering the ocean. Different economic sectors are therefore taking respective actions to mitigate this environmental impact. To date, bio-based materials such as poly lactic acid (PLA), degradable in appropriate conditions), polyhydroxyalkanoates (PHA) and polyethylene (PE, non-degradable) have been reported as alternatives to plastic products mainly because of their mechanical properties. Other main alternatives include polysaccharides such as starch, chitosan, alginate, and fibers such as cellulose from wood. One of the main advantages of the latter alternative is the low cost of the raw materials in comparison with conventional polymers, their availability and their valorization as products. In addition, natural fibers are a renewable source of material, and an alternative to oil-based polymers. Hence, natural fibers may be used to produce packaging biodegradable materials suitable for food applications and may help counter the negative effect caused by Styrofoam food packaging.

Industrial production of fiber-based packaging is a relatively recent process. Hence, there are challenges that need to be overcome to achieve the required standards in the food industry. This is especially the case for food packaging as it is subject to rigorous norms. Indeed, mechanical properties must be respected such as resistance, rigidity, impermeability (i.e. to oil and water), microwave and freezer resistance.

### SUMMARY

A first aspect herein disclosed is a biodegradable food article comprising:
about 60 wt. % to about 98 wt. %, on a dry basis, of natural fibers; and
about 1 wt. % to about 40 wt. %, on a dry basis, of at least one additive, wherein the biodegradable food article comprises at least one of the following properties:
impermeable to liquids;
able to withstand freezing;
able to withstand microwave heating;
biodegradable in about 60 to about 65 days under suitable biodegradation conditions;
compostable; and
made of food grade material.

An another aspect herein disclosed is a method of producing a biodegradable food article, the method comprising:
providing raw fibers;
reducing the size of the raw fibers;
mixing the fibers with a liquid to obtain a slurry;
mixing at least one additive to the slurry, and
thermoforming the additive-containing slurry to obtain the biodegradable food article.

Another aspect is a biodegradable food article obtained according to the method disclosed herein.

Yet another aspect is a biodegradable food article made of fibers and an oil.

### BRIEF DESCRIPTION OF THE DRAWINGS

In the following drawings, which represent by way of example only, various embodiments of the disclosure:

FIG. 1 is a perspective view of a set of food trays according to an embodiment;

FIG. 2 is a top view of the food tray of FIG. 1;

FIG. 3 is a side view of the food tray of FIG. 1; and

FIG. 4 is a top view of a food tray according to another embodiment.

### DETAILED DESCRIPTION

Unless otherwise indicated, the definitions and examples described herein are intended to be applicable to all embodiments and aspects of the present disclosure herein described for which they are suitable as would be understood by a person skilled in the art.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The term “% wt.” or “wt. %” as used herein when describing an ingredient present in a mixture or composite, refers to the weight % of this ingredient based on the total weight of the mixture or composite.

Disclosed herein are eco-responsible food articles (e.g. containers and trays) made of natural fibers that are biodegradable, compostable, recyclable, whilst abiding with all the mechanical properties which are built in, to fulfill the food industry requirements.

For example, the biodegradable food article comprises about 70 wt. % to about 98 wt. %, on a dry basis, of natural fibers. For example, the biodegradable food article comprises about 80 wt. % to about 98 wt. %, on a dry basis, of natural fibers. For example, the biodegradable food article comprises about 85 wt. % to about 98 wt. %, on a dry basis, of natural fibers. For example, the biodegradable food article comprises about 90 wt. % to about 98 wt. %, on a dry basis, of natural fibers.

For example, the natural fibers may be obtained from biomass materials. For example, the natural fibers comprise wood fibers, hemp fibers, flax fibers, warbler fibers, cannabis fibers, and mixtures thereof. For example, the wood fibers are commercial soft wood fibers. For example, the soft wood fibers are unbleached kraft soft fibers. For example, the soft wood fibers are bleached kraft soft fibers.

For example, the biodegradable food article comprises about 1 wt. % to about 30 wt. %, on a dry basis, of the at least one additive. For example, the biodegradable food article comprises about 1 wt. % to about 20 wt. %, on a dry basis, of the at least one additive. For example, the biodegradable food article comprises about 1 wt. % to about 10 wt. %, on a dry basis, of the at least one additive. For example, the biodegradable food article comprises about 1 wt. % to about 8 wt. %, on a dry basis, of the at least one additive. For example, the biodegradable food article comprises about 1 wt. % to about 6 wt. %, on a dry basis, of the at least one additive.

For example, the fibers have a size of about 0.5 mm to about 5 mm. For example, the fibers have a size of about 1.0 mm to about 4 mm. For example, the fibers have a size of about 1.5 mm to about 3 mm.

For example, the at least one additive is chosen from a water-proofing agent, an oil-proofing agent, a sizing agent, a filler, a binding agent, a stabilizer, and mixtures thereof.

For example, the at least one additive is an oil-proofing agent. For example, the oil-proofing agent is a perfluoroalkyl group agent. For example, the perfluoroalkyl group agent is AG-E060.

For example, the at least one additive is a water-proofing agent. For example, the water-proofing agent is a perfluoroalkyl group agent. For example, the perfluoroalkyl group agent is AG-E060.

For example, the biodegradable food article comprises:

about 60 wt. % to about 98 wt. %, on a dry basis, of natural fibers; and
about 1 wt. % to about 40 wt. %, on a dry basis, of perfluoroalkyl group agent.

For example, the biodegradable food article comprises:

about 90 wt. % to about 98 wt. %, on a dry basis, of natural fibers; and
about 1 wt. % to about 4 wt. %, on a dry basis, of perfluoroalkyl group agent.

For example, the biodegradable food article consists essentially of:

about 60 wt. % to about 98 wt. %, on a dry basis, of natural fibers; and
about 1 wt. % to about 40 wt. %, on a dry basis, of perfluoroalkyl group agent.

For example, the biodegradable food article consists essentially of:

about 90 wt. % to about 98 wt. %, on a dry basis, of natural fibers; and
about 1 wt. % to about 4 wt. %, on a dry basis, of perfluoroalkyl group agent.

For example, the biodegradable food article consists of:

about 60 wt. % to about 98 wt. %, on a dry basis, of natural fibers; and
about 1 wt. % to about 40 wt. %, on a dry basis, of perfluoroalkyl group agent.

For example, the biodegradable food article consists of:

about 90 wt. % to about 98 wt. %, on a dry basis, of natural fibers; and
about 1 wt. % to about 4 wt. %, on a dry basis, of perfluoroalkyl group agent.

For example, the biodegradable food article is biodegradable in about 60 to about 65 days under suitable biodegradation conditions. For example, suitable biodegradation conditions and compostability conditions are set out in the following standards: CAN/BNQ-0017-088 Standard, ISO 17088:2012 Standard, ASTM D6400 Standard and ASTM D6868 Standard.

For example, the biodegradable food article is compostable.

For example, the biodegradable food article meets at least one of CAN/BNQ-0017-088 Standard, ISO 17088:2012 Standard, ASTM D6400 Standard and ASTM D6868 Standard.

For example, the biodegradable food article is stackable.

For example, the biodegradable food article is a recipient, optionally a plate, a bowl or a cup.

For example, the biodegradable food article is a food tray. For example, the food tray is a vegetable tray, a meat tray or a fish tray.

For example, the food tray has a plurality of borders extending upwardly and outwardly, the borders having at least one of: a length of about 130 mm to about 275 mm; a width of about 130 mm to about 220 mm; and a height of about 10 mm to about 50 mm.

For example, the food tray has a thickness of about 0.5 mm to about 1.5 mm.

Also disclosed herein is a method for producing a biodegradable food article.

For example, the raw fibers are natural raw fibers. Natural fibers are produced by animals, plants and geological processes, and occur in the fiber shape. For example, the natural raw fibers comprise wood fibers, hemp fibers, flax fibers, warbler fibers, cannabis fibers, and mixtures thereof. For example, the wood fibers are commercial soft wood fibers. For example, the soft wood fibers are unbleached kraft soft fibers (e.g. resinous wet material). For example, the soft wood fibers are bleached kraft soft fibers (e.g. resinous wet material).

In an embodiment, raw fibers are crushed to the desired size. For example, the reducing the size comprises mechanically crushing, triturating and/or grinding the raw fibers.

The size of the fibers at the output of this step may for example be between 1.5-3 mm. For example, the raw fibers are reduced to a size of about 0.5 mm to about 5 mm. For example, the raw fibers are reduced to a size of about 1.0 mm to about 4 mm. For example, the raw fibers are reduced to a size of about 1.5 mm to about 3 mm.

For example, when the raw fibers are hemp fibers, the method further comprises retting the raw fibers to separate the fibers from the stem prior to reducing the size of the raw fibers.

The shortened raw material, that may consist of fibers (unbleached Kraft soft wood, bleached Kraft soft wood, hemp, flax, warbler, cannabis or mixtures thereof) are then mixed with a liquid e.g. water to form a slurry.

For example, the liquid is water.

For example, the desired slurry consistency is achieved by selecting the amount of added water or by applying some pressure to the slurry by means of a matched mold.

For example, the slurry has a fiber content of about 0.3 wt. % to about 4.0 wt. %. For example, the slurry has a fiber content of about 0.6 wt. % to about 2.5 wt. %. For example, wherein the slurry has a fiber content of about 0.8 wt. % to about 2.0 wt. %.

The slurry is then mixed in order to achieve homogeneity that will help achieve the final product's desired characteristics.

For example, the at least one additive is chosen from a water and oil proofing agent, a sizing agent, a filler, a binding agent, a stabilizer, and mixtures thereof.

For example, the at least one additive is an oil-proofing agent. For example, the oil-proofing agent is a perfluoroalkyl group agent. For example, the perfluoroalkyl group agent is AG-E060.

For example, the at least one additive is a water-proofing agent. For example, the water-proofing agent is a perfluoroalkyl group agent. For example, the perfluoroalkyl group agent is AG-E060.

The very low surface tension of the perfluoroalkyl group product permits to resist to water, oil and other liquids such as alcoholic liquids. The oil and water proofing agent may be added for example in a range of about 0.5% to about 1% of the total amount of the slurry.

For example, the slurry has an oil-proofing agent content and/or a water-proofing agent content of about 0.25 wt. % to about 2.0 wt. %. For example, the slurry has an oil-proofing agent content and/or a water-proofing agent content of about 0.50 wt. % to about 1.5 wt. %. For example, the slurry has an oil-proofing agent content and/or a water-proofing agent content of about 0.5 wt. % to about 1.0 wt. %.

For example, the slurry has an additive content of about 2.0 wt. % and a slurry content of about 98.0%.

For example, the additive may be added to the fibers at the same time as the liquid (e.g. water) is added to the water. For example, the additive may be added to the pulp comprising the fibers and liquid.

The slurry (e.g. finished pulp) is then sent to the thermoforming stage, where it will be molded into the desired food article product.

For example, the thermoforming comprises:

pouring the slurry into a mold;

vacuum-forming the slurry; and

curing the slurry to obtain the biodegradable food article.

For example, the slurry is vacuum-formed using a vacuum of about 10 mmHg to 75 mmHg. For example, the slurry is vacuum-formed using a vacuum of about 15 mmHg to 35 mmHg. For example, the slurry is vacuum-formed using a vacuum of about 15 mmHg to 30 mmHg. For example, the slurry is vacuum-formed using a vacuum of 23 mmHg.

For example, the thermoforming comprises pressing the slurry for about 5 seconds to about 20 seconds. For example, the thermoforming comprises pressing the slurry about 5 seconds to about 15 seconds. For example, the thermoforming comprises pressing the slurry for about 10 seconds.

For example, the liquid contained in the molded slurry is drained for about 30 seconds to about 60 seconds. For example, the liquid contained in the molded slurry is drained for about 40 seconds to about 50 seconds. For example, the liquid contained in the molded slurry is drained for about 45 seconds.

For example, the curing is carried out at a temperature of about 150° C. to about 250° C. For example, the curing is carried out at a temperature of about 175° C. to about 225° C. For example, the curing is carried out at a temperature of about 190° C. to about 210° C. For example, the curing is carried out at a temperature of about 200° C.

For example, the thermoforming is carried out using a time series between about 5 seconds and about 55 seconds.

For example, the biodegradable food article is removed from the mold.

For example, the biodegradable food article is removed from the mold using compressed air.

For example, the biodegradable food article is stacked and packaged.

For example, the biodegradable food article is a recipient, optionally a plate, a bowl or a cup.

For example, the biodegradable food article is a food tray.

For example, the food tray is a vegetable tray, a meat tray or a fish tray.

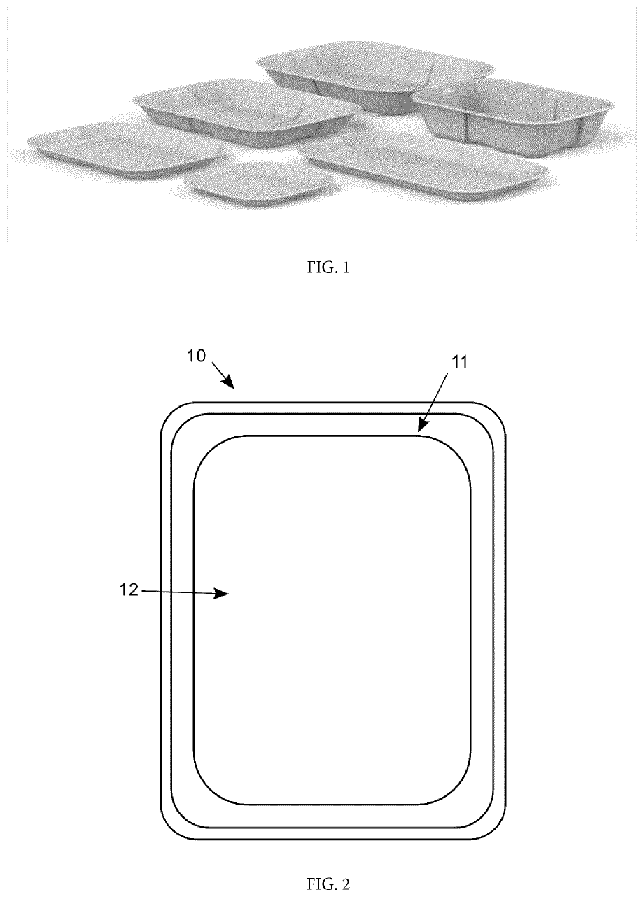

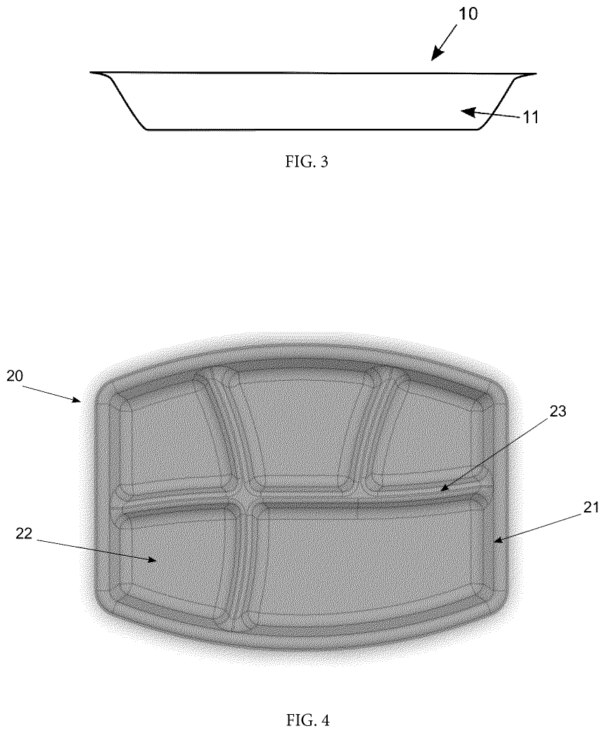

In a non-limiting embodiment, the method is directed to producing a food tray. Initially, the slurry is at ambient temperature. It is then placed under vacuum. The vacuum may be of 23 mmHg. The pulp is molded and drained for 10 and 45 seconds per article respectively. The molds are heated to a temperature of 200° C. The strategy of thermomoulding uses a time series between 5-55 seconds. It will be understood that a time series refers to the time needed to perform a thermoforming operation of either pressing or resting. In one non-limiting example, the thermoforming comprises pressing the molded slurry for about 5 seconds, resting for 10 seconds, pressing for 50 seconds, resting for 20 seconds and pressing for 15 seconds. Other suitable time series may be used. The distance between two molds may be for example of 1 mm. Finally, the food trays are removed from the mold through compressed air, stacked and packaged. Figures of the food trays are shown in FIGS. 1, 2, 3 and 4.

For example, the food tray has a plurality of borders extending upwardly and outwardly, the borders having at least one of: a length of about 130 mm to about 275 mm; a width of about 130 mm to about 220 mm; and a height of about 10 mm to about 50 mm.

For example, the food tray has a thickness of about 0.5 mm to about 1.5 mm.

For example, the biodegradable food article is biodegradable in about 60 to about 65 days, under suitable biodegradation conditions.

For example, the biodegradable food article is compostable.

For example, the biodegradable food article meets at least one of CAN/BNQ-0017-088 Standard, ISO 17088:2012 Standard, ASTM D6400 Standard and ASTM D6868 Standard.

For example, the biodegradable food article is a food grade article as there is substantially no contamination or interaction between the biodegradable food article and food contained therein.

For example, the article is substantially impermeable to liquids, optionally water, grease and/or oil.

For example, the article is washable, microwaveable and/or freezable.

To date, technologies used to create barriers to water and oil are plastic films and emulsions. The particularity of the presently disclosed food article is that all mechanical proprieties are built-in due to a combination of fiber type, precision of the structure of the fiber, temperature, pressing draining and drying.

1-95. (canceled)

96. A biodegradable food article comprising:
about 85 wt. % to about 98 wt. %, on a dry basis, of natural fibers having a size of about 0.5 mm to about 5 mm; and
about 1 wt. % to about 15 wt. %, on a dry basis, of at least one additive, wherein the biodegradable food article comprises at least one of the following properties:
impermeable to liquids;
able to withstand freezing;
able to withstand microwave heating;
biodegradable in about 60 to about 65 days under suitable biodegradation conditions;
compostable; and
made of food grade material.

97. The biodegradable food article of claim 96, comprising about 90 wt. % to about 98 wt. %, on a dry basis, of natural fibers.

98. The biodegradable food article of claim 96, wherein the natural fibers comprise wood fibers, hemp fibers, flax fibers, warbler fibers, cannabis fibers, and mixtures thereof.

99. The biodegradable food article of claim 98, wherein the wood fibers are soft wood fibers.

100. The biodegradable food article of claim 99, wherein the soft wood fibers are unbleached kraft soft wood fibers.

101. The biodegradable food article of claim 96, wherein the natural fibers have a size of about 1.0 mm to about 4 mm.

102. The biodegradable food article of claim 96, comprising about 1 wt. % to about 10 wt. %, on a dry basis, of the at least one additive.

103. The biodegradable food article of claim 96, comprising about 1 wt. % to about 8 wt. %, on a dry basis, of the at least one additive.

104. The biodegradable food article of claim 96, comprising about 1 wt. % to about 6 wt. %, on a dry basis, of the at least one additive.

105. The biodegradable food article of claim 96, wherein the at least one additive is chosen from a water-proofing agent, an oil-proofing agent, a sizing agent, a filler, a binding agent, a stabilizer, and mixtures thereof.

106. The biodegradable food article of claim 105, wherein the at least one additive is an oil-proofing agent.

107. The biodegradable food article of claim 106, wherein the oil-proofing agent is a perfluoroalkyl group agent.

108. The biodegradable food article of 96, wherein the at least one additive is a water-proofing agent.

109. The biodegradable food article of claim 96, wherein the biodegradable food article is compostable.

110. The biodegradable food article of claim 96, wherein the biodegradable food article meets at least one of CAN/BNQ-0017-088 Standard, ISO 17088:2012 Standard, ASTM D6400 Standard and ASTM D6868 Standard.

111. The biodegradable food article of claim 96, wherein the biodegradable food article is stackable.

112. The biodegradable food article of claim 96, wherein the biodegradable food article is a recipient.

113. The biodegradable food article of claim 96, wherein the biodegradable food article is a food tray.

114. The biodegradable food article of claim 113, wherein the food tray has a plurality of borders extending upwardly and outwardly, the borders having at least one of: a length of about 130 mm to about 275 mm; a width of about 130 mm to about 220 mm; and a height of about 10 mm to about 50 mm.

115. The biodegradable food article of claim 113, wherein the food tray has a thickness of about 0.5 mm to about 1.5 mm.
